(19) United States
(12) Patent Application Publication
(10) Pub. No.: US 2003/0115290 A1
(43) Pub. Date: Jun. 19, 2003

(54) Inquiry reception system

(76) Inventor: Masato Mori, Saitama-city (JP)

Correspondence Address: RABIN & CHAMPAGNE, PC, 1101 14TH STREET, NW, SUITE 500, WASHINGTON, DC, 20005, US

(21) Appl. No.: 10/195,445

(22) Filed: Jul. 16, 2002

(30) Foreign Application Priority Data
Dec. 13, 2001 (JP) 2001-380211

(51) Int. Cl. G06F 15/16

(52) U.S. Cl. 709/219

(57) ABSTRACT

An inquiry reception system provides a verified and authorized reply to an inquiry. The system permits the sending of an improved reply and to improve an operator's skill by verifying the reply by a supervisor before the reply prepared by the operator is sent and by feeding back the result of the verification to the operator. The system includes the reply input terminal at which the reply is prepared in response to the inquiry, the reply verification terminal at which the reply is verified and a reply without any defect is authorized, and the server at which the inquiry is received and the authorized reply is sent. The reply verification terminal informs the reply input terminal of any defect found by the verification.

### BACKGROUND OF THE INVENTION

1) Field of the Invention

The present invention relates to a reception system in response to an inquiry from customers.

2) Description of the Related Art

In order to respond to various inquiries from customers regarding services and products, a company often establishes a call center which receives the inquiries by phone beside a reception counter at a store front or a company office. In such a case, an operator at the call center manages to respond to each customer's inquiry by referring to various information regarding the company such as matters of business, services, and description of products, in compliance with customer's inquiries which are received by phone.

Furthermore, because of the progress of IT (Information Technology) and prevalence of the Internet in recent years, use of the Internet has remarkably increased for receiving inquiries via electronic mail or by a web home page through the Internet. Under the circumstances, it has become common to apply a reception system wherein retrieval of all contents of the inquiries is carried out by a computer system for an efficient response and automatic analysis and sorting of the contents of the inquiries, which are conducted by a text-mining function. By utilizing the reception system, working efficiency is remarkably improved since workload of the operator who prepares a reply to an inquiry is alleviated, and moreover, a job quality is refined as the reply is improved.

In the conventional inquiry reception system, however, customers may receive a reply which includes mistakes or improper expressions since the operator's reply is directly sent to customers. In such case, it may create a problem between the customer and the company.

In order to avoid the problem, it may be effective that only a reply verified and authorized by a supervisor is sent to the customer after the reply is prepared by the operator. However, this will require much labor and will be time consuming to solve the problem when a defect is found during the verification of the reply, since the supervisor must call over each operator who made the defect and then clarify the defect or a correction of the defect by verbal communication or instruct the operator about the correction by showing handwritten comments on the printed papers. It is not a good idea that the supervisor himself corrects the defect and directly sends the corrected reply to the customer when the defect is found during the verification of the reply, because improvement of the operator's skill is not expected as the operator who made the defect has no opportunity to recognize the defect.

### SUMMARY OF THE INVENTION

The present invention has been developed to solve the foregoing problems of the reception system and it is an object of the present invention to provide an inquiry reception system, in which a reply prepared by an operator is verified by a supervisor before the reply is sent to a customer and a result of the verification by the supervisor is fed back to the operator so as to prepare an improved reply to the customer from the operator and improve the operator's skill.

According to one aspect of the present invention, there is provided an inquiry reception system comprising a reply input terminal in which a reply is prepared in response to an inquiry from a customer, a reply verification terminal in which the reply is verified and then authorized when no defect is found in the reply, and a server by which the inquiry is received and the authorized reply is sent to the customer. The reply verification terminal transmits any defect found by the verification to the reply input terminal.

Therefore, the reply to the customer is improved and the operator's skill is improved.

The reply verification terminal may also correct the defect, and update and authorize the reply.

The reply verification terminal may also send back the reply including the defect to the reply input terminal.

The reply verification terminal may send back the reply including the defect to the reply input terminal selected in accordance with a specified condition.

The reply verification terminal may send a message regarding the defect to the reply input terminal.

The message is, for example, a voice message or a handwritten message.

The reply verification terminal may verify the reply selected in accordance with a predetermined condition.

The reply verification terminal may verify the reply selected by the reply input terminal.

According to another aspect of the present invention, there is provided an inquiry reception system comprising a reply input terminal in which a reply is prepared in response to an inquiry from a customer, a reply verification terminal in which the reply is verified and then authorized when no defect is found in the reply, and a server by which the inquiry is received and the authorized reply is sent to the customer. The server collects statistics relating to an operator who prepared the reply based on the defect found by the verification and contents of the reply.

The server may include a database which records the processed statistics regarding the defect of the reply.

### BRIEF DESCRIPTION OF THE DRAWINGS

FIG. 1 illustrates the first embodiment of the inquiry reception system of the present invention.

FIG. 2 illustrates a function of the inquiry reception system shown in FIG. 1.

FIG. 3 illustrates a function of the inquiry reception system of the second embodiment of the present invention.

FIG. 4 illustrates a function of the inquiry reception system of the third embodiment of the present invention.

FIG. 5 illustrates an example of the management information in the operator management database of the fourth embodiment of the present invention.

FIG. 6 illustrates a function of the inquiry reception system of the fifth embodiment of the present invention.

FIG. 7 illustrates a function of the inquiry reception system of the sixth embodiment of the present invention.

### DETAILED DESCRIPTION OF THE INVENTION

Embodiments of the present invention will hereinafter be described in detail with reference to the accompanying drawings.

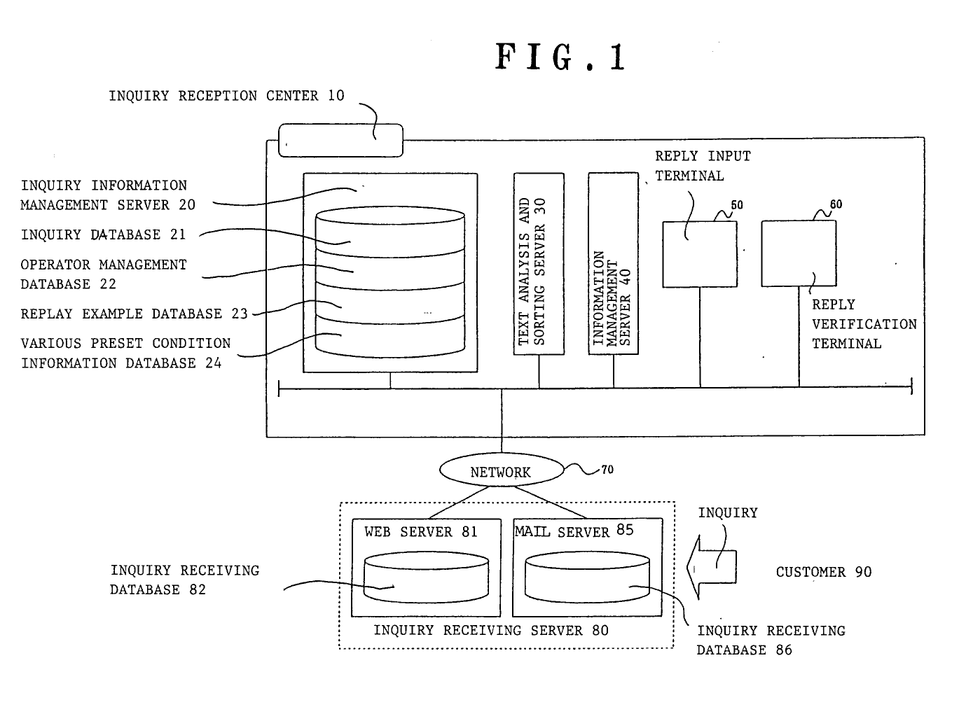

Referring to FIG. 1, the first embodiment of the inquiry reception system of the present invention is illustrated.

In the drawing, reference numeral 10 designates the inquiry reception center for receiving electronic mail or a written input to a web home page through the Internet from a customer 90. The inquiry reception center 10 receives the electronic mail from the customer 90 concerning various aspects of a company and organization such as matters of business, services, products, and advertisements. The company and organization may be a financial agency such as bank and credit bank, security company, insurance company, manufacturing company or distributing company which produces or distributes products such as computer, software, automobiles, electrical appliance and electronics, stores such as department stores and supermarkets, accommodations such as American and Japanese style hotels, and transport companies for tourists such as railroads and airlines. The inquiry reception center 10 also receives various inquiries, consultations, claims, requests and so on (hereinafter referred to as inquiries) which are sent by the written inquiry to the web home page through the Internet. An operator then prepares a reply and sends the reply to the customer 90 by electronic mail.

The inquiry reception center 10 includes an inquiry information management server 20. The inquiry information management server 20 includes an inquiry database 21 which manages inquiry information, an operator management database 22, a reply example database 23 which registers database information regarding examples of inquiries prepared in advance and examples of replies in response to the inquiries, and various preset condition information database 24. Most inquiries responded to by the inquiry reception center 10 are categorized into a specific problem. Therefore, it is preferable to pre-register examples of the inquiry and examples of the reply in pair combination as information of reply examples in the reply example database 23. The reply examples are prepared in response to the inquiry example which is assumed to be frequently asked based on experience.

Furthermore, the inquiry reception center 10 includes a reply input terminal 50, a reply verification terminal 60, an information management server 40, and a text analysis and sorting server 30. At the reply input terminal 50, the contents of the inquiry and various retrieved information are displayed, and then the operator prepares the reply in response to the inquiry from the customer 90. At the reply verification terminal 60, the reply prepared by the operator is verified by the supervisor and the reply without any defect is authorized. At the information management server 40, an information (e.g., brochure, information about home pages on the Internet, and manual) which is referred to in preparation for the reply in response to the inquiry is accumulated. At the text analysis and sorting server 30, whole contents of the inquiry is retrieved (searched), automatically analyzed using a text-mining function, automatically sorted, and so on. The automatic analysis includes extraction by keyword, sorting, arrangement, and so on.

In the embodiment, the inquiry information management server 20, the text analysis and sorting server 30, the information management server 40, the reply input terminal 50, and the reply verification terminal 60 are computers including an arithmetic unit such as CPU and MPU, a storage device such as magnetic disk and semiconductor memory, an input unit such as keyboard and mouse, a display unit such as CRT and liquid crystal display, a communication interface, and so on. These computers are connected to each other for communication.

The inquiry reception center 10 receives the inquiry from the customer 90 by the electronic mail or by writing in the web home page, etc. at an inquiry receiving server 80, which includes a web server 81 and a mail server 85. The web server 81 and the mail server 85 includes an inquiry receiving database 82 and 86, respectively, which stores the inquiry information. The inquiry from the customer 90 is transferred from the inquiry receiving server 80 to the inquiry reception center 10 via a network 70 such as the intranet, LAN (Local Area Network), WAN (Wide Area Network), the Internet. The inquiry receiving server 80 and the inquiry information management server 20 may be combined into a single unit.

The reply verification terminal 60 may be installed at a different place, i.e., a remote place such as headquarters, from the reply input terminal 50.

A function of the inquiry reception system which has a configuration described above will hereinafter be described.

As long as the inquiry reception center 10 utilizes the electronic mail for sending the reply to the customer 90, the inquiry from the customer 90 can be received by any manner such as phone, facsimile, and mail. For the descriptive purpose, the embodiment of the present invention will be hereinafter described based on the case that the inquiry to the inquiry reception center 10 from the customer 90 is received by the electronic mail or by the writing in the web home page.

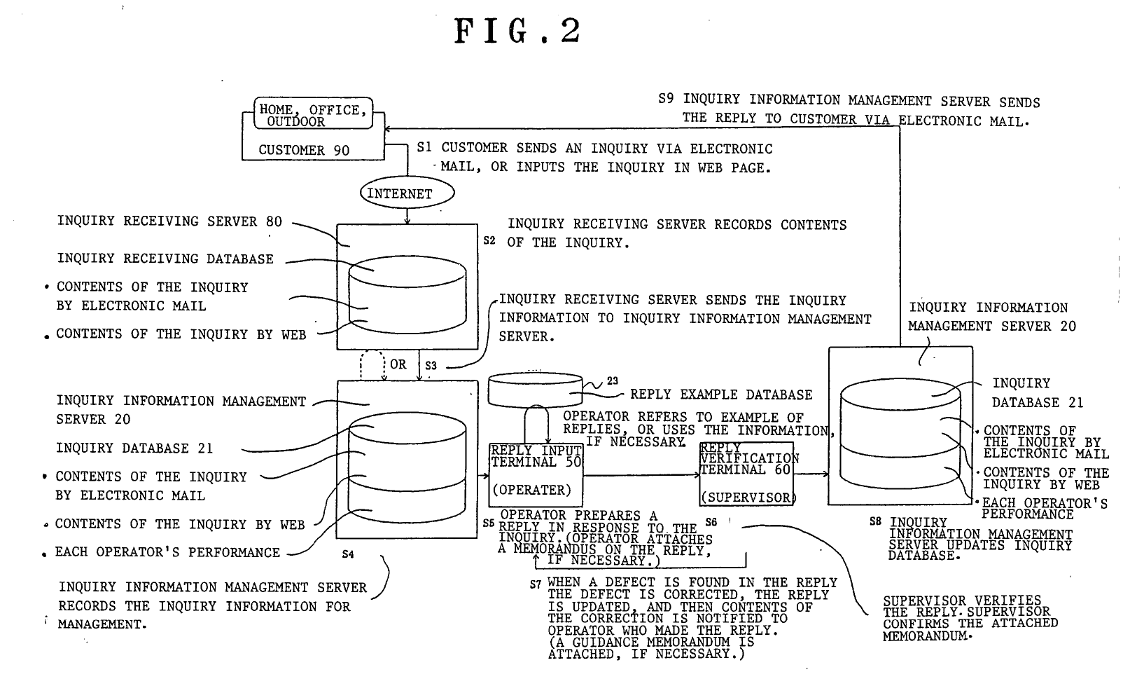

FIG. 2 illustrates a function of the inquiry reception system of the first embodiment (FIG. 1) of the present invention.

First, the customer 90 operates a personal computer etc. at home, office, outdoor, etc. to accesses a home page of the company etc. to which he wants to make an inquiry via web such as the Internet and then opens a web page of inquiry to input the inquiry in a specified column of the web page. The customer 90 may send the inquiry to an electronic mail address in the electronic mail form by obtaining an electronic mail address of the company etc.

When the customer 90 inputs the inquiry in the inquiry web page, the web server 81 in the inquiry receiving server 80 sends the inquiry information to the inquiry information management server 20 in the inquiry reception center 10 via the network 70 together with recording the inquiry information in the inquiry receiving database 82. The inquiry information means contents of the inquiry, name and electronic mail address of the person who sends the inquiry, and so on. Meanwhile, when the customer 90 sends the inquiry to the electronic mail address of the company etc. in the electronic mail form, the mail server 85 in the inquiry receiving server 80 sends the inquiry information to the inquiry information management server 20 in the inquiry reception center 10 via the network 70 together with recording the inquiry information in the inquiry receiving database 86. The inquiry information management server 20 records the received inquiry information in the inquiry database 21 for storage.

Next, an operator operates the reply input terminal 50 to obtain the inquiry information, of which the reply is not yet prepared, from the inquiry database 21, and prepares a reply in response to the inquiry. On the occasion of preparing the reply, the operator may refer to the information such as example of replies registered in the reply example database 23, brochure, information about home pages on the Internet, and manual, which are filed and managed in the information management server 40 and may copy the necessary part of the information.

When the operator wants to notify a supervisor of information other than the reply, contents of such information (e.g., memorandum that demands special attention which is not sent to the customer 90 with the reply) is incorporated into the reply. The reply is then registered. After that, the reply is sent to the reply verification terminal 60.

A supervisor, then, operates the reply verification terminal 60 to visualize the inquiry information together with the prepared reply on the display unit of the reply verification terminal 60, and verifies the reply by confirming the contents of the inquiry, reply, and attached memorandum.

When the supervisor finds a defect in the reply by the verification, he/she corrects the defect and updates the reply. In this case, the updated reply is re-registered, and contents of the correction in the updated reply is notified to the operator at the reply input terminal 50 who prepared the reply by the style that the place and the manner of the correction of the reply can be clearly identified. Various styles are available for the identification; hatching on the corrected place in the reply, changing font type or color of letters, and comparing before and after the correction. The present invention is not limited to the above mentioned styles.

Contents of the correction can be notified to the operator who prepared the reply by either sending contents of the correction via the electronic mail or automatic notification to the reply input terminal 50. In the latter case, the automatic notification is triggered by the input and registration of the correction by the supervisor and the contents of the correction can be confirmed by the operator's additional action at the reply input terminal 50. It is also allowed to show a list of corrected replies, e.g., a list of bad examples, on the display units of the reply input terminal 50 for those operators who prepared the wrong replies, or to show whole lists of corrected replies on all display units of the reply input terminals 50 for all operator's confirmation.

In addition, instructive messages and advice for the operator who prepared the reply will be informed to the operator's reply input terminal 50 together with the corrected reply by the supervisor, if necessary. The message is input by the supervisor on the occasion of correcting and updating the defect of the reply.

Next, the reply which is already verified and authorized, i.e., the reply that the supervisor has verified and authorized, or the reply that the supervisor has corrected, updated, and re-registered, is sent to the inquiry information management server 20 for recording and updating the inquiry database 21. Then, the inquiry information management server 20 sends the reply already verified and authorized to the customer 90 in the electronic mail form. The customer 90 is able to obtain an appropriate reply by opening the electronic mail received at personal computer etc. at home, office, outdoor, etc.

Next, each step shown in FIG. 2 will be described.

Step S1: The customer 90 sends an inquiry via the electronic mail or inputs the inquiry in web page.

Step S2: The inquiry receiving server 80 records contents of the inquiry.

Step S3: The inquiry receiving server 80 sends the inquiry information to the inquiry information management server 20.

Step S4: The inquiry information management server 20 records the inquiry information for management.

Step S5: An operator obtains the inquiry information which is not yet replied from the inquiry database 21, and prepares a reply in response to the inquiry. The operator also attaches a memorandum on the reply, if necessary.

Step S6: A supervisor verifies the reply prepared by the operator. The supervisor also confirms the attached memorandum.

Step S7: When the supervisor finds a defect in the reply, he/she corrects the defect, updates the reply, and then notifies the operator who prepared the reply of contents of the correction. An instructive (coach) memorandum is attached, if necessary.

Step S8: The inquiry information management server 20 records the reply verified and authorized, and then updates the inquiry database 21.

Step S9: The inquiry information management server 20 sends the authorized reply to the customer 90 via the electronic mail.

In this embodiment, the reply is first prepared by the operator by operating the reply input terminal 50 in response to the inquiry from the customer 90, and then the reply is verified and authorized by the supervisor by operating the reply verification terminal 60, and finally the reply verified and authorized is sent to the customer 90 by the inquiry information management server 20. The first embodiment can therefore prevent the customer 90 from obtaining an unsuitable reply, and avoid troubles with the customer 90.

The first embodiment can also instantly correct the defect of the operator's reply found by the verification, and inform the operator of the contents of the correction. The first embodiment can therefore improve operator's skill, and avoid similar mistakes.

The first embodiment can also show whole lists of corrected replies on all display units of the reply input terminals 50 for all operator's confirmation. The first embodiment can therefore improve skill and morale of all operators engaged in the inquiry reception center 10 by disclosing the bad examples.

In the first embodiment, the supervisor can inform the operator of instructions or advice for the operator who prepared the reply. The first embodiment can therefore give accurate instructions to the operator without a face to face interview.

In the first embodiment, the operator can incorporate a memorandum into the reply when the operator has uncertainty in the reply or has a comment/question which should be informed to the supervisor. The first embodiment can therefore let the operator prepare a suitable reply under the control of the supervisor and also let the operator receive the adequate instructions by the notification to the supervisor.

The second embodiment of the present invention will hereinafter be described. As the configuration of the inquiry reception center of the second embodiment is similar to that of the first embodiment, FIG. 1 will be used for the following description.

In the first embodiment, workload of the supervisor will be rather hard as the supervisor himself corrects the defect when the defect is found by the verification of the reply. The second embodiment of the present invention, therefore, alleviates the workload of the supervisor at the reply verification terminal 60 by sending back the reply including the defect to the operator who prepared the reply after the verification of the reply.

The second embodiment instructs the operator regarding corrections by attaching a voice file of the supervisor so that the instructions are conveyed readily. In the reply verification terminal 60, a microphone (not shown) is provided as an input unit in order to attach the voice file to the data sent back to the operator.

A function of the inquiry reception system will hereinafter be described.

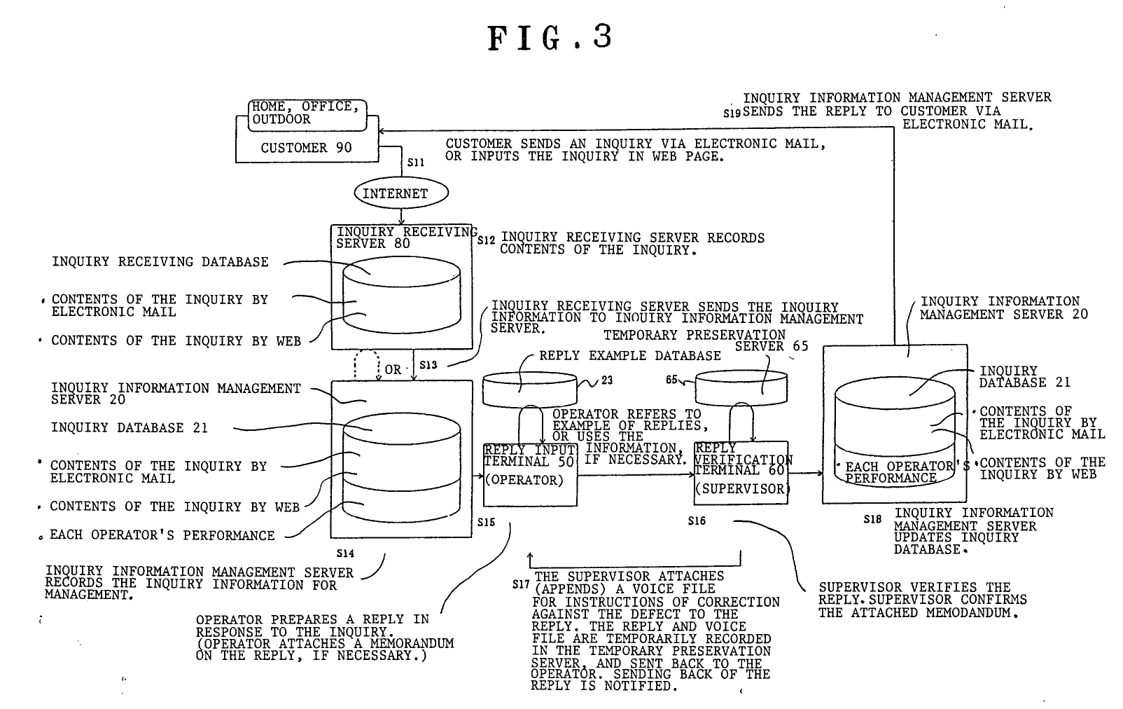

FIG. 3 illustrates a function of the inquiry reception system of the second embodiment.

A description of the following operation is omitted from the description of the second embodiment because the operation is similar to that of the first embodiment; up to the preparation for the reply by the operator in response to the customer's inquiry and the verification of the reply by the supervisor at the reply verification terminal 60 (Step S1 to S6).

The supervisor takes an action to send back the reply to the operator (e.g., pushing a sending back button) when the defect is found in the reply by the verification. Subsequently, a voice comment recording function automatically starts up and the supervisor inputs the voice (message) using the microphone connected with the reply verification terminal 60. The voice message may include places and contents of the defect, contents of the correction or request for correction against the defect, instructions, and advice. Once a terminate action of the sending back is activated by the supervisor, the message is sent back to the operator together with the reply. It is preferable to install a temporary preservation server 65 in order to record and reserve the reply temporarily as illustrated in FIG. 3.

The reply attached with the supervisor's voice message, e.g., voice file such as WAVE file, is sent to the reply input terminal 50 of the operator who prepared the reply. The supervisor may identify the place among the reply which needs to be corrected for easy identification in a manner such as hatching, changing font type, and changing color of letters by operating the input unit such as mouse and keyboard at the reply verification terminal 60. It is preferable that the reply verification terminal 60 has a function to manually or automatically number the places which need to be corrected so as to clearly point out the places when the reply has a plurality of correcting places.

Next, the operator who receives the sent back reply visualizes the reply on a display unit of the reply input terminal 50, confirms the supervisor's voice message, and then corrects and re-registers the reply. The supervisor is able to easily identify the returned reply, which is sent back, corrected, and re-registered, in re-verifying at the reply verification terminal 60 because the reply has a mark of “sent back” or “corrected”. The supervisor is also able to confirm the supervisor's voice message during the re-verification of the returned reply, if necessary, because the voice message is still attached to the reply returning to the reply verification terminal 60. It is preferable that the reply which is sent back, corrected, and re-registered is returned to a supervisor at a reply verification terminal 60 who sent back the reply when a plurality of supervisors have their own reply verification terminals 60.

The supervisor re-verifies contents of the returned reply, and then authorizes the reply when the correction on the reply is appropriate. Then, the same correction is made by overwriting in the reply temporarily reserved in the temporary preservation server 65, and sent to the inquiry information management server 20. The supervisor may re-send back the reply when the supervisor determines that the correction made in the returned reply is still inappropriate after re-verification of the returned reply. The reply which is sent back, corrected, and re-registered may be sent to the inquiry information management server 20 without re-verification.

The inquiry information corresponding the sent back reply may be distributed to the operator at the reply input terminal 50 as a top priority information when the reply is sent back, i.e., the inquiry information of the sent back reply is shown on the display unit at the reply input terminal 50 as a job which should be treated next to the current job, or the reply input terminal 50 automatically shifts to the correcting mode. Furthermore, it is allowed that notification to the operator regarding the sending back of the reply is prepared by voice instructions so as to request the operator to shift to the correcting mode.

A description after the reply verified and authorized is sent to the inquiry information management server 20 is omitted from the description of the second embodiment as the operation is similar to that of the first embodiment.

Next, each step shown in FIG. 3 will be described.

Step S11: The customer 90 sends an inquiry via the electronic mail or inputs the inquiry in web page.

Step S12: The inquiry receiving server 80 records contents of the inquiry.

Step S13: The inquiry receiving server 80 sends the inquiry information to the inquiry information management server 20.

Step S14: The inquiry information management server 20 records the inquiry information for management.

Step S15: The operator obtains the inquiry information which is not yet replied from the inquiry database 21, and prepares (inputs) a reply in response to the inquiry. The operator also attaches a memorandum to the reply, if necessary.

Step S16: The supervisor verifies the contents of the reply prepared by the operator. The supervisor also confirms the attached memorandum.

Step S17: When the supervisor finds a defect in the reply, he/she attaches (appends) a voice file for instructions of correction against the defect to the reply. The reply and voice file are temporarily recorded in the temporary preservation server, and sent back to the operator. Sending back of the reply is notified by voice.

Step S18: The inquiry information management server 20 records the reply verified and authorized, and then updates the inquiry database 21.

Step S19: The inquiry information management server 20 sends the authorized reply to the customer 90 via the electronic mail.

In this embodiment, the reply, which is prepared by the operator at the reply input terminal 50 in response to the inquiry from the customer 90, is sent back to the operator at the reply input terminal 50 when the supervisor finds the defect in verifying the reply. This embodiment can therefore alleviate the workload of the supervisor since the supervisor himself does not need to correct the defect.

In this embodiment, the supervisor's voice message can be appended to the sending back reply as the voice file. This embodiment can therefore alleviate the supervisor's workload in operating the keyboard, and give clear instructions to the operator regarding the correction of the defect.

In this embodiment, it is also possible to correct the reply reliably since the operator is able to confirm the message at anytime repeatedly during correcting the sent back reply, and to increase the rate of the operation since the operator is able to correct the defect even if the supervisor is in the absence.

In this embodiment, the supervisor is able to verify the contents of the correction precisely since the reply which is corrected by the operator is returned to the supervisor at the reply verification terminal 60 who instructed the correction.

In this embodiment, it is also possible to notify the operator who prepared the reply, by the voice instructions, of a fact that the reply is sent back. In this embodiment, therefore, the operator can easily confirm that the reply is sent back.

The third embodiment of the present invention will hereinafter be described. As the configuration of the inquiry reception system of the third embodiment is similar to that of the first embodiment, FIG. 1 will be used for the following description.

In the second embodiment, the supervisor's voice message is sent to the operator who prepared the reply by attaching the voice file to the sending back reply. However, it may be preferable by writing down the instructive memorandum at the place of the defect in the reply which needs to be corrected. The third embodiment of the present invention, therefore, has a function to write down the memorandum by touching the reply panel shown on the display unit at the reply verification terminal 60 by a pen or a finger.

In the reply verification terminal 60, a touch sensor (not shown) by which an input is made by the pen or the finger is provided.

A function of the inquiry reception system will hereinafter be described.

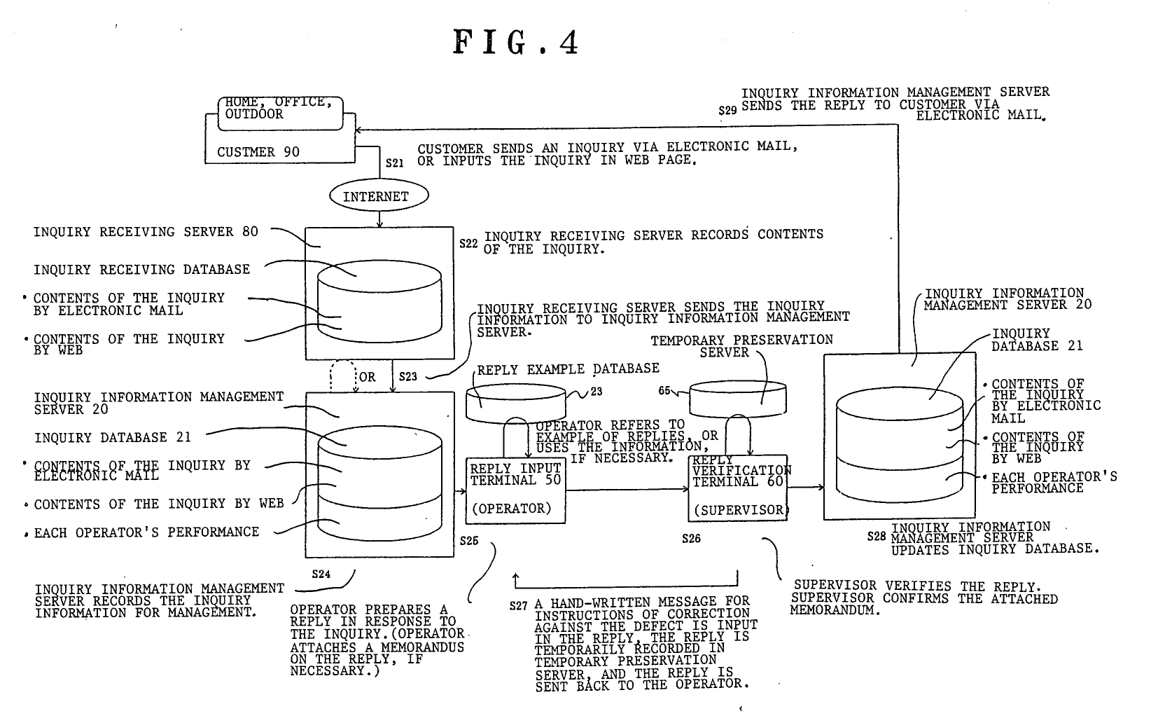

FIG. 4 illustrates a function of the inquiry reception system of the third embodiment.

A description of the following operation is omitted from the description of the third embodiment because the operation is similar to that of the first and second embodiments; up to the preparation for the reply by the operator in response to the customer's inquiry and the verification of the reply by the supervisor at the reply verification terminal 60 (Step S1 to S6).

The supervisor takes an action to send back the reply to the operator (e.g., pushing a sending back button) when the defect is found in the reply by the verification. Subsequently, an input mode by the pen or finger writing starts up and the supervisor inputs (writes) letters and/or figures in the reply shown on the display of the reply verification terminal 60. The supervisor, for example, indicates places and contents of the defect, contents of the correction or request for correction against the defect, instructions, and advice. Since an eraser function is provided, a part or whole of the input message can be deleted. Once a terminate action of the sending back is activated by the supervisor, the message is sent back to the operator together with the reply. It is preferable to install the temporary preservation server 65 in order to record and reserve the reply temporarily as illustrated in FIG. 4. The reply with the supervisor's message is sent to the reply input terminal 50 of the operator who prepared the reply.

Next, the operator who receives the sent back reply visualizes the reply on a display unit of the reply input terminal 50, confirms the supervisor's message (instructions), and then corrects and re-registers the reply. The image data of the handwritten message input by the supervisor is shown on the display such that the image data of the message overlaps the reply. It is preferable that the system has a function to change the display mode (e.g., the message is not shown in a first mode, only the message is shown in a second mode, and both the message and the reply are shown in a third mode) for readiness of the confirmation of the supervisor's comments by pushing a certain button at the input unit of the reply input terminal 50.

The supervisor is able to easily identify the returned reply, which is sent back, corrected, and re-registered, in re-verifying at the reply verification terminal 60 because the reply has a mark of “sent back” or “returned”. The supervisor is also able to confirm the supervisor's message during the re-verification of the returned reply, if necessary, because the message is still attached to the reply returning to the reply verification terminal 60. It is preferable that the reply which is sent back, corrected, and re-registered is returned to the supervisor at the reply verification terminal 60 who sent back the reply when a plurality of supervisors have their own reply verification terminals 60.

The supervisor re-verifies contents of the returned reply, and then authorizes the reply when the correction on the reply is appropriate. Then, the same correction is made by overwriting in the reply temporarily reserved in the temporary preservation server 65, and sent to the inquiry information management server 20. The supervisor may re-send back the returned reply when the supervisor determines that the correction made in the returned reply is still inappropriate after re-verification of the returned reply. The reply which is sent back, corrected, and re-registered may be sent to the inquiry information management server 20 without reverification.

The inquiry information corresponding the sent back reply may be distributed to the operator at the reply input terminal 50 as a top priority information when the reply is sent back, i.e., the inquiry information of the sent back reply is shown on the display unit at the reply input terminal 50 as a job which should be treated next to the current job, or the reply input terminal 50 automatically shifts to the correcting mode. Furthermore, it is allowed that notification to the operator regarding the sending back of the reply is prepared by voice instructions so as to request the operator to shift to the correcting mode.

A description after the reply verified and authorized is sent to the inquiry information management server 20 is omitted from the description of the third embodiment as the operation is similar to that of the first and second embodiment.

Next, each step shown in FIG. 4 will be described.

Step S21: The customer 90 sends an inquiry via the electronic mail or inputs the inquiry in web page.

Step S22: The inquiry receiving server 80 records contents of the inquiry.

Step S23: The inquiry receiving server 80 sends the inquiry information to the inquiry information management server 20.

Step S24: The inquiry information management server 20 records the inquiry information for management.

Step S25: The operator obtains the inquiry information which is not yet replied from the inquiry database 21, and prepares (inputs) a reply in response to the inquiry. The operator also attaches a memorandum to the reply, if necessary.

Step S26: The supervisor verifies the contents of the reply prepared by the operator. The supervisor also confirms the attached memorandum.

Step S27: When the supervisor finds a defect in the reply, he/she inputs (writes) a handwritten message for instructions of correction against the defect to the reply. The reply and message are temporarily recorded in the temporary preservation server, and sent back to the operator.

Step S28: The inquiry information management server 20 records the reply verified and authorized, and then updates the inquiry database 21.

Step S29: The inquiry information management server 20 sends the authorized reply to the customer 90 via the electronic mail.

In this embodiment, the reply, which is prepared by the operator at the reply input terminal 50 in response to the inquiry from the customer 90, is sent back to the operator at the reply input terminal 50 when the supervisor finds the defect in verifying the reply. This embodiment can therefore alleviate the workload of the supervisor since the supervisor himself does not need to correct the defect.

In this embodiment, the supervisor's handwritten message can be added to the sending back reply. This embodiment can therefore alleviate the supervisor's workload in operating the keyboard, and give clear instructions to the operator regarding the correction of the defect.

In this embodiment, it is also possible to correct the reply reliably since the operator is able to confirm the message at anytime repeatedly during correcting the reply, and to increase the rate of the operation since the operator is able to correct the defect even if the supervisor is in the absence.

The embodiment has an advantage that the confirmation of the message can be carried out reliably since the message is shown (displayed) over the reply.

In this embodiment, the supervisor is able to verify the contents of the correction precisely since the reply which is corrected by the operator is returned to the supervisor at the reply verification terminal 60 who instructed the correction.

In this embodiment, the supervisor is able to readily reconfirm the contents of instructions since the reply which is corrected by the operator is returned to the supervisor who instructed the correction at the reply verification terminal 60 together with the supervisor's message.

The fourth embodiment of the present invention will hereinafter be described. As the configuration of the inquiry reception system of the fourth embodiment is similar to that of the first embodiment, FIG. 1 will be used for the following description.

In the first through third embodiments, an attempt is made to improve the operator's skill by feeding back the message which includes instructive comments or advice to the operator who prepared the reply after the supervisor finds the defect in verifying the operator's reply. In this case, correction of the defect is carried out by either the supervisor or the operator. However, the system has no function to know (find out) how often each operator makes mistakes. Moreover, the operators mainly consist of part-time employees and temporary employees dispatched from other companies, recently. It is therefore required to correctly evaluate each operator's ability for management and to announce each operator's performance for the prevention of frequent occurrence of the defect.

The fourth embodiment, therefore, includes a management function to manage the operator's performance such as the number of the jobs per each operator and the defects made in each job, at the inquiry information management server 20. The system enables to evaluate the operator's skill or performance from the viewpoints of the number of defects, the degree of the defect, and the detailed contents of the defect. The degree of the defect can be categorized as follows; e.g., light: a few typological errors, middle: correction of the expression or many typological errors, and serious: correction of whole contents.

The inquiry information management server 20 has the above-described management function. The management function statistically processes the information of each operator from the viewpoints of the defects found by the verification and the statistical result is recorded in the operator management database 22 for the management.

A function of the inquiry reception system will hereinafter be described.

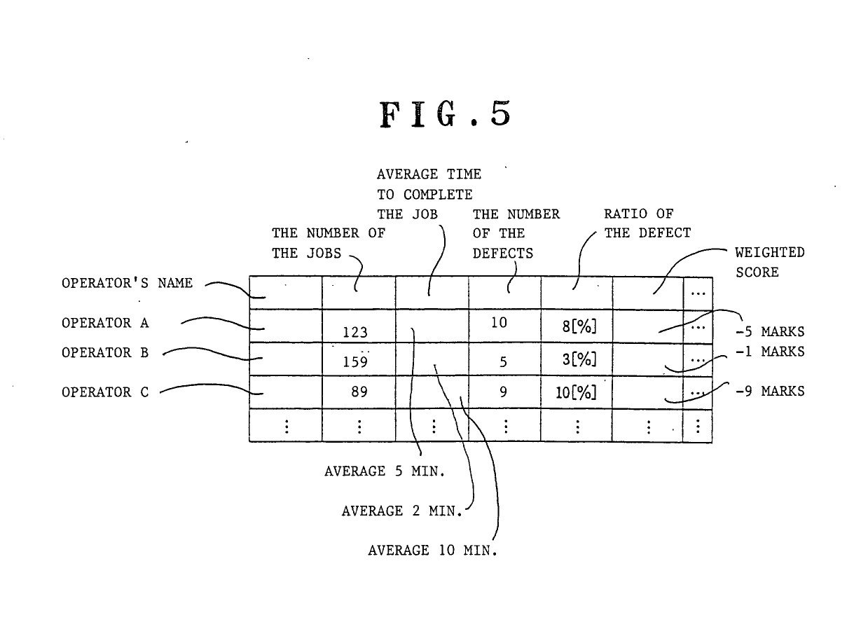

FIG. 5 illustrates an example of management information in the operator management database of the fourth embodiment.

As shown in the illustration, the operator management database 22 records the information for the management such as the operator's name, the number of the jobs, time spent to complete each job, the number of the defects, ratio of the defects, weighted score.

A description of the following operation is omitted from the description of the fourth embodiment because the operation is similar to that of the first embodiment; up to the preparation for the reply by the operator in response to the customer's inquiry and the verification of the reply by the supervisor at the reply verification terminal 60 (Step S1 to S6). The fourth embodiment can be applied to the second and third embodiments of the invention.

When the defect is found in the reply by the verification, the supervisor inputs or selects the degree of the defect among the specified categories at the reply verification terminal 60, e.g., light defect: a few typological errors, middle defect: correction of the expression or many typological errors, and serious defect: correction of whole contents. The inquiry information management server 20 then registers and counts the degree of the defect for that operator in the operator management database 22.

The defect may includes not only negative, but also positive. For example, it may be preferable to give positive evaluation to the operator who prepared an outstanding reply which is useful for a model (standard) example. The statistical information of each operator's performance may be output on the display unit of the reply verification terminal 60 for management by the supervisor, or on all operators' display units of the reply input terminals 50 at any time so as to increase the motivation of all the operators.

The system may have a function to setup a threshold value, which is obtained from the number of the defects or calculated from the number of the defects and the degree of the defect, so as to automatically inform the supervisor at the reply verification terminal 60 of the operator's name, the number of the defects, and the score when the operator's defect exceeds the threshold value within a specified period.

A description of operations other than mentioned above in the fourth embodiment is omitted as the operation is similar to that of the first through third embodiments.

This embodiment has a function to process the information of the operator's defect in the reply found by the verification and output the processed information as each operator's performance. This embodiment can therefore readily evaluate the operator's performance and improve the quality of the management because the supervisor is able to instruct the operator based on the performance.

In this embodiment, each operator can confirm his/her own disclosed performance at any time. This embodiment can therefore let the operators be conscious about their performances and thus reduce the defect rate in preparation for the reply by improving morale and skill of all operators.

The fifth embodiment of the present invention will hereinafter be described. As the configuration of the inquiry reception system of the fifth embodiment is similar to that of the first embodiment, FIG. 1 will be used for the following description.

In the first through fourth embodiments, all the replies prepared by the operators are verified by the supervisors, which leads to an increase of the workload of the supervisors at the reply verification terminals 60 and also leads to an increase of the required number of the reply verification terminals 60. The fifth embodiment of the present invention is, therefore, adapted to designate (decide) a condition to select the reply to be verified.

A function of the inquiry reception system will hereinafter be described.

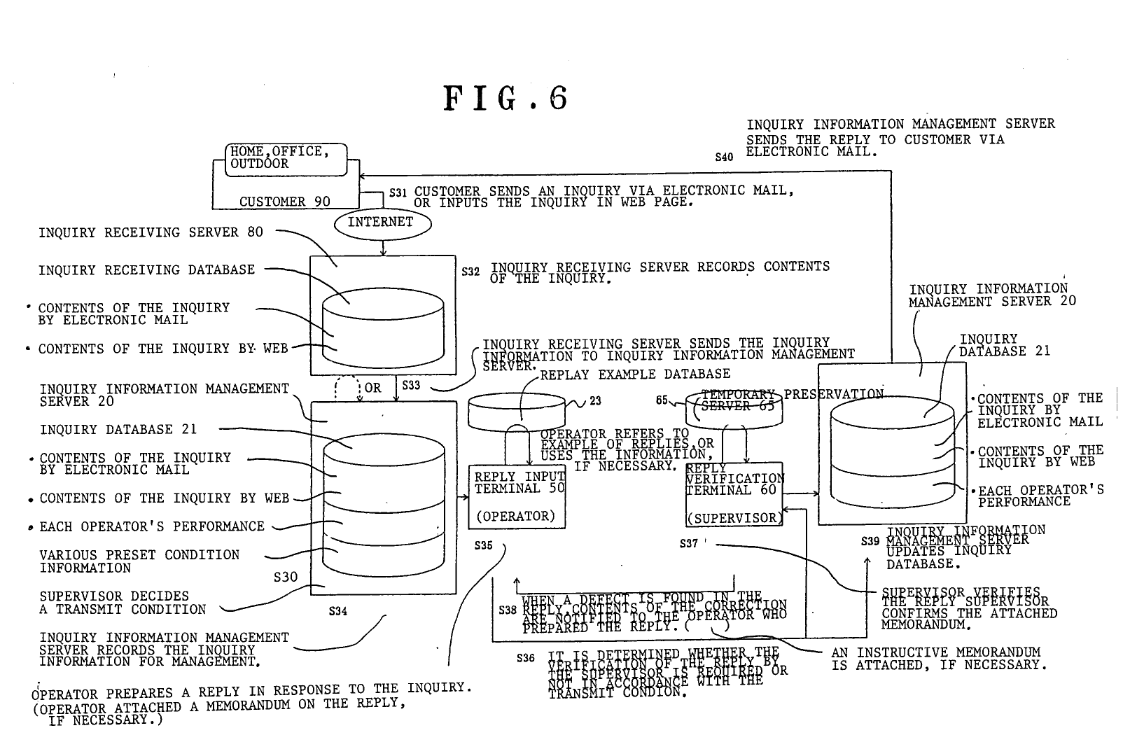

FIG. 6 illustrates a function of the inquiry reception system of the fifth embodiment.

First of all, the supervisor designates a transmit condition, i.e., the condition by which the reply is selected and sent to the reply verification terminal 60, at the inquiry information management server 20 in order to select the reply which needs to be verified. In designating the transmit condition, the category of inquiry can be applied. For example, only the replies concerning claim or consultation are sent to the supervisor for the verification among various categories such as just inquiry, claim, consultation, and request of brochure. Alternatively, the reply is excluded from the verification when it is just a copy of an example of the reply registered in the reply example database 23, and the reply is verified in other cases (e.g., modification is made on the example of the reply or the reply is originally prepared by the operator). Alternatively, the reply is verified when it is prepared by a particular operator such as less experienced operator and poor performance operator. Alternatively, the reply is verified when it is responded to the inquiry from certain types of customers such as a good regular customer and a problem customer.

A description of the following operation is omitted from the description of the fifth embodiment because the operation is similar to that of the first embodiment; up to the preparation for the reply by the operator in response to the customer's inquiry and the verification of the reply by the supervisor at the reply verification terminal 60 (Step S1 to S6). The fifth embodiment can be applied to the second through fourth embodiments of the invention.

The fifth embodiment determines whether the verification of the reply prepared and registered by the operator is required, from the viewpoint of the transmit condition. The reply determined to be verified is sent to the reply verification terminal 60 for the verification by the supervisor. The reply determined not to be verified is sent to the inquiry information management server 20 and stored in a “delivery waiting” section. The inquiry database 21 in the inquiry information management server 20 is then updated.

A description of operations other than mentioned above in the fifth embodiment is omitted as the operation is similar to that of the first through fourth embodiments.

Next, each step shown in FIG. 6 will be described.

Step S30: The supervisor decides a transmit condition.

Step S31: The customer 90 sends an inquiry via the electronic mail or inputs the inquiry in web page.

Step S32: The inquiry receiving server 80 records contents of the inquiry.

Step S33: The inquiry receiving server 80 sends the inquiry information to the inquiry information management server 20.

Step S34: The inquiry information management server 20 records the inquiry information for management.

Step S35: The operator obtains the inquiry information which is not yet replied from the inquiry database 21, and prepares (inputs) a reply in response to the inquiry. The operator also attaches a memorandum to the reply, if necessary.

Step S36: It is determined whether the verification of the reply by the supervisor is required or not in accordance with the transmit condition. Go to step S37 if the verification is required, and go to step S39 if not.

Step S37: The supervisor verifies the contents of the reply prepared by the operator. The supervisor also confirms the attached memorandum.

Step S38: When the supervisor finds a defect in the reply, he/she notifies the operator who prepared the reply of contents of the correction. An instructive (coach) memorandum is attached, if necessary.

Step S39: The inquiry information management server 20 records the reply verified and authorized, and then updates the inquiry database 21.

Step S40: The inquiry information management server 20 sends the authorized reply to the customer 90 via the electronic mail.

Thus, this embodiments can select the reply for the supervisor's verification based on the transmit condition designated in advance. This embodiment can therefore minimize the workload of the supervisor.

The sixth embodiment of the present invention will hereinafter be described. As the configuration of the inquiry reception system of the sixth embodiment is similar to that of the first embodiment, FIG. 1 will be used for the following description.

In the fifth embodiment, there may be a case that the reply is not verified, notwithstanding the operator's desire to receiving instructions from the supervisor, since the reply to be verified is selected based on the transmit condition which is designated from the supervisor's viewpoints. In the sixth embodiment of the present invention, therefore, the operator is able to decide that the reply which the operator is now preparing at the reply input terminal 50 needs to be verified by the supervisor.

A function of the inquiry reception system will hereinafter be described.

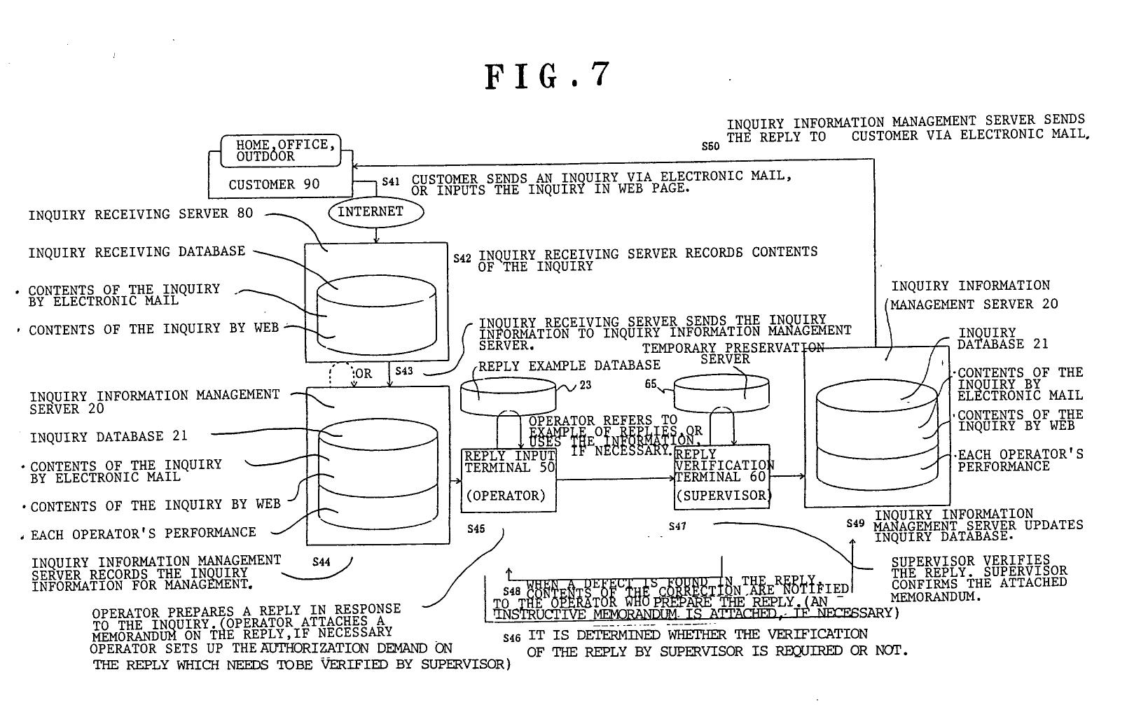

FIG. 7 illustrates a function of the inquiry reception system of the sixth embodiment.

A description of the following operation is omitted from the description of the sixth embodiment because the operation is similar to that of the fifth embodiment; up to the preparation for the reply by the operator in response to the customer's inquiry and the verification of the reply by the supervisor at the reply verification terminal 60 (Step S31 to S37). The sixth embodiment can be applied to second through fourth embodiments of the invention.

When the operator requests the reply to be verified by the supervisor, the operator sets up the authorization demand, for example pushing a certain button to make a request for the supervisor's authorization, before completing the reply. Then the reply is recognized to be verified by the supervisor and sent to the reply verification terminal 60 for the verification irrespective of the transmit condition. The reply on which the supervisor's verification is not requested by the operator is sent to the inquiry information management server 20 and stored in the “delivery waiting” section. Then the inquiry database 21 in the inquiry information management server 20 is updated.

It is preferable that the reply, on which the authorization demand is set up, is marked as such when the reply is shown on the display unit of the reply verification terminal 60. It is also preferable to inform the operator of the result of the verification or the message by the supervisor regardless of the suitability of the reply.

A description is omitted here with respect to the following operation since it is similar to that of the fifth embodiment; deciding the reply to be verified by the supervisor in accordance with the transmit condition designated in advance, or functions/operation other than described above in the sixth embodiment.

Next, each step shown in FIG. 7 will be described.

Step S41: The customer 90 sends an inquiry via the electronic mail or inputs the inquiry in web page.

Step S42: The inquiry receiving server 80 records contents of the inquiry.

Step S43: The inquiry receiving server 80 sends the inquiry information to the inquiry information management server 20.

Step S44: The inquiry information management server 20 records the inquiry information for management.

Step S45: The operator obtains the inquiry information which is not yet replied from the inquiry database 21, and prepares (inputs) a reply in response to the inquiry. The operator also attaches a memorandum to the reply, if necessary. The operator further sets up the authorization demand on the reply which needs to be verified by the supervisor.

Step S46: It is determined whether the verification of the reply by the supervisor is required or not in accordance with the authorization demand and/or the transmit condition. Go to step S47 if the verification is required, and go to step S49 if not.

Step S47: The supervisor verifies the contents of the reply prepared by the operator. The supervisor also confirms the attached memorandum.

Step S48: When the supervisor finds a defect in the reply, he/she notifies the operator who prepared the reply of contents of the correction. An instructive (coach) memorandum is attached, if necessary.

Step S49: The inquiry information management server 20 records the reply verified and authorized, and then updates the inquiry database 21.

Step S50: The inquiry information management server 20 sends the authorized reply to the customer 90 via the electronic mail.

This embodiment sets up the authorization demand for the verification of the reply by the supervisor when the operator has no confidence on the reply. This embodiment can therefore alleviate operator's concern and minimize the defect of the reply.

In this embodiment, the authorization demand can be set up readily since the set up is made by the selection at the reply input terminal 50.

This embodiment can also alleviate operator's concern, i.e., to improve operator's confidence as well as skill, since the result of the verification or message regarding the reply, on which authorization demand is set up, is notified to the operator from the supervisor regardless of the suitability of the reply.

The seventh embodiment of the present invention will hereinafter be described. As the configuration of the inquiry reception system of the seventh embodiment is similar to that of the first embodiment, FIG. 1 will be used for the following description.

In the second through sixth embodiments, the reply is sent back to the operator who prepared the reply, which may lead to a stagnancy of the subsequent jobs if the operator is coming home or in vacation. In the seventh embodiment of the present invention, therefore, the reply with the defect can be transferred to a selected (specified) operator at another reply input terminal 50 in accordance with the designated conditions.

In the inquiry information management server 20, a function to control (decide) the specified operator (i.e., the transfer destination) is provided. The specified operator may be designated based on the operator's workload. For example, the reply is automatically transferred to an operator who has no job if such operator is found by monitoring the status of the operators at the reply input terminals 50. The specified operator may be an operator who is specialized in the correction of the sent back reply. The reply is sent to the operators who did not prepare the reply, when a particular condition is met. For instance the condition is met when the terminal (50) designed to operate with the ID number owned by the operator who prepared the reply is turned off. This means absence of the operator. Alternatively the condition is met when the specified period is expired without any reply by the operator who prepared the reply. The above-described conditions do not limit the present invention and other conditions may be used.

The supervisor may designate (enter, decide) the condition by visualizing a condition entry screen on the display unit at the reply verification terminal 60. In this case, the inquiry information management server 20 is able to decide the transfer destination of the reply automatically by controlling the condition designated by the supervisor.

A function of the inquiry reception system will hereinafter be described.

A description of the following operation is omitted from the description of the seventh embodiment because the operation is similar to that of the second embodiment; up to the preparation for the reply by the operator in response to the customer's inquiry and the verification of the reply by the supervisor at the reply verification terminal 60 (Step S11 to S16). The seventh embodiment can be applied to the third through sixth embodiments of the invention.

The supervisor takes an action to send back the reply to the operator (e.g., by pushing the sending back button) when the defect is found in the reply by the verification. Subsequently, the reply is sent back to the specified operator at the reply input terminal 50 in accordance with the condition of the transfer destination.

Next, the operator who receives the sent back reply corrects the reply based on the instructions of the supervisor, and re-registers the reply.

A description of operations and functions other than described above are omitted as they are similar to those of the second embodiment.

In this embodiment, the reply is sent back to the operator specified in accordance with the condition of the destination when the supervisor found the defect in verifying the reply. This embodiment can, therefore, correct the reply without any delay and prevent stagnancy in case that the operator who prepared the reply is in absence.

It should be understood that the present invention is not limited to the above-described embodiments, and various changes and modifications can be made without departing from the scope of the invention.

It should be also understood that the present invention can be applied to an inquiry not only from any person but also from a non-person.

What is claimed is:

1. An inquiry reception system comprising:
a reply input terminal in which a reply is prepared in response to an inquiry;
a reply verification terminal in which the reply is verified and authorized when a defect is absent in the reply; and
a server by which the inquiry is received and the authorized reply is sent, wherein
the reply verification terminal transmits any defect found by verification to the reply input terminal.

2. The inquiry reception system of claim, 1 wherein the reply verification terminal corrects the defect, and updates and authorizes the reply.

3. The inquiry reception system of claim 1, wherein the reply verification terminal sends back the reply including the defect to the reply input terminal.

4. The inquiry reception system of claim 3 further comprising at least one more reply input terminal, wherein the reply verification terminal sends back the reply including the defect to a reply input terminal selected in accordance with a specified condition.

5. The inquiry reception system of claim 1, wherein the reply verification terminal sends a message regarding the defect to the reply input terminal.

6. The inquiry reception system of the claim 5, wherein the message is one of a voice message and a handwritten message.

7. The inquiry reception system of claim 1, wherein the reply verification terminal verifies the reply selected in accordance with a predetermined condition.

8. The inquiry reception system of claim 1, wherein the reply verification terminal verifies a reply selected by the reply input terminal.

9. An inquiry reception system comprising:
a reply input terminal in which a reply is prepared in response to an inquiry;
a reply verification terminal in which the reply is verified and authorized when a defect is absent in the reply; and
a server by which the inquiry is received and the authorized reply is sent, wherein
the server collects statistics relating to an operator who prepared the reply based on the defect found by verification and contents of the reply.

10. The inquiry reception system of claim 9, wherein the server includes a database which records the statistics processed relating to the defect of the reply.
